(19) United States
(12) Patent Application Publication
(10) Pub. No.: US 2026/0236102 A1
(43) Pub. Date: Aug. 13, 2026

(54) INFORMATION PROCESSING APPARATUS AND INFORMATION PROCESSING METHOD

(71) Applicant: CANON KABUSHIKI KAISHA, Tokyo (JP)

(72) Inventors: Kosuke NOBUOKA, Kanagawa (JP); Takayuki YASUDA, Kanagawa (JP)

(21) Appl. No.: 19/464,732

(22) Filed: Jan. 30, 2026

(30) Foreign Application Priority Data
Feb. 4, 2025 (JP) 2025-016786

(51) Int. Cl. G06F 3/01; G09B 5/02

(52) U.S. Cl. CPC G06F 3/016; G06F 3/011; G09B 5/02

(57) ABSTRACT

An information processing apparatus includes a processor; and a memory storing a program which, when executed by the processor, causes the information processing apparatus to execute detection processing of detecting a contact state with respect to a virtual object to which a tactile effect is imparted, execute acquisition processing of acquiring an index indicating a difference between a first contact state with respect to the virtual object and a second contact state with respect to the virtual object, the second contact state being detected in a time different from the first contact state or in a space different from the first contact state, and execute generation processing of generating, based on the index, auxiliary information for a user contacting the virtual object in the second contact state to contact the virtual object in the first contact state.

### BACKGROUND

### Field of the Technology

The present disclosure relates to an information processing apparatus and an information processing method.

### Description of the Related Art

Skills, such as ceramics, in which tactile sense with fingers is important, have been traditionally handed down and learned in an instruction style in which a learner directly receives instruction from an instructor. In such an instruction style, it is not possible that the learner and the instructor touch the object (clay molded into the shape of a vessel in the case of ceramics) handled by the instructor at the same time. It is difficult for the learner to share tactile feedback to the fingers, which is important for skill acquisition, with the instructor, and it generally takes a long time for the learner to acquire the skill. In addition, the practical limit of the number of learners that can be instructed by the instructor at one time is several to ten-odd. The higher the skill level, the fewer the number of learners the instructor can instruct. A instructor often performs instruction on a one-to-one basis. If the learner can share tactile feedback on the fingers of the virtual object with the instructor, the learner can efficiently acquire skills.

A technique of giving tactile feedback of a virtual object to a bare hand by using ultrasonic sound pressure has been studied. According to this technique, a plurality of users can share a common sense of touch of a virtual object by using a tactile feedback environment assigned to each user.

“Tactile rendering to the finger surface by aerial ultrasonic control” (Atsushi Matsubayashi, Sep. 18, 2020, University of Tokyo academic institution repository, [searched on Jan. 10, 2025], Internet <URL: https://repository.dl.itc.u-tokyo.ac.jp/records/2006438>) discloses a technique for providing tactile sense by ultrasonic sound pressure. A finger of a user is photographed by a plurality of depth cameras, and point group data of the hand acquired from the captured image is dynamically converted into a polygon mesh model. By optimizing the amplitude and phase of the ultrasonic vibrator array with respect to the position of the finger that is determined to be in contact with the virtual object from the positional relationship between the virtual object and the polygon mesh model of the hand, it is possible to give a tactile sense by the ultrasonic sound pressure to the finger of the user.

International Publication No. WO2020/090943 discloses an information transmission system in which a skilled person can transmit the position of his/her gaze destination to a cooperator in real time while viewing the same video as that of the cooperator, and transmit the movement of his/her fingertip in a three-dimensional direction to each finger of the cooperator in real time as a sense of force to perform instruction.

Even if a skilled person can transmit the movement of his/her fingertip to each finger of the cooperator as a sense of force in real time, it is difficult for the cooperator (learner) to share how to apply the force to the virtual object with the skilled person (instructor) depending on the contact state with the virtual object which is the target object. In addition, in a case where the contact state with the virtual object is different from that of the instructor, it is difficult for the learner to share the tactile feedback from the virtual object with the instructor.

### SUMMARY

The present disclosure provides an information processing apparatus that assists in reproducing a contact state with respect to a virtual object even at different times or in different spaces.

A first embodiment of the present disclosure is an information processing apparatus including a processor; and a memory storing a program which, when executed by the processor, causes the information processing apparatus to: execute detection processing of detecting a contact state with respect to a virtual object to which a tactile effect is imparted; execute acquisition processing of acquiring an index indicating a difference between a first contact state with respect to the virtual object and a second contact state with respect to the virtual object, the second contact state being detected in a time different from the first contact state or in a space different from the first contact state; and execute generation processing of generating, based on the index, auxiliary information for a user contacting the virtual object in the second contact state to contact the virtual object in the first contact state.

A second embodiment of the present disclosure is an information processing method including detecting a contact state with respect to a virtual object to which a tactile effect is imparted; acquiring an index indicating a difference between a first contact state with respect to the virtual object and a second contact state with respect to the virtual object, the second contact state being detected in a time different from the first contact state or in a space different from the first contact state; and generating, based on the index, auxiliary information for a user contacting the virtual object in the second contact state to contact the virtual object in the first contact state.

A third embodiment of the present disclosure is a non-transitory computer-readable medium that stores a program, wherein the program causes a computer to execute an information processing method comprising: detecting a contact state with respect to a virtual object to which a tactile effect is imparted; acquiring an index indicating a difference between a first contact state with respect to the virtual object and a second contact state with respect to the virtual object, the second contact state being detected in a time different from the first contact state or in a space different from the first contact state; and generating, based on the index, auxiliary information for a user contacting the virtual object in the second contact state to contact the virtual object in the first contact state.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an information processing apparatus according to a first embodiment.

FIG. 2 is a diagram for explaining a polygon mesh model.

FIG. 3 is a flowchart illustrating contact state detection processing.

FIG. 4A is an example of a hand polygon mesh model of an instructor. FIG. 4B is an example of a hand polygon mesh model of a learner. FIG. 4C is an example of a virtual object polygon mesh model.

FIGS. 5A and 5B are diagrams for explaining generation of polygon data of a virtual object.

FIGS. 6A and 6B are diagrams illustrating display examples of a hand and a virtual object.

FIGS. 7A and 7B are diagrams illustrating a notification example of a contact state between a hand and a virtual object.

FIGS. 8A and 8B are diagrams illustrating a notification example of the shape change of the virtual object.

FIG. 9 is a diagram illustrating a configuration of an information processing apparatus according to a second embodiment.

FIG. 10 is a graph illustrating an evaluation result by a shape change evaluation unit.

FIG. 11 is a diagram illustrating a notification example of the contact state between the hand and the virtual object.

FIG. 12 is a diagram illustrating a configuration of an information processing apparatus according to a third embodiment.

FIG. 13 is a diagram illustrating a configuration of a rotation angle detector.

FIGS. 14A and 14B are diagrams illustrating display examples in a case where a virtual object is rotated.

FIG. 15 is a diagram illustrating a timing chart of a rotation control signal.

FIG. 16 is a diagram illustrating a configuration of a rotation processing unit.

### DESCRIPTION OF THE EMBODIMENTS

Hereinafter, an embodiment of the present disclosure will be described with reference to the drawings. Each embodiment will be described by an example in which an instructor and a learner use the information processing apparatus according to the present disclosure to hand down or acquire ceramics, which is a traditional skill in which tactile sense with fingers is important.

If a target object to be a skill target is set as a virtual object, and a tactile effect of the virtual object can be given to a learner as tactile feedback, it is possible to propose a new style of skill guidance and acquisition that is not realized in the real world. The information processing apparatus can shorten the acquisition time and increase the number of people who can perform instruction by giving the tactile effect of the virtual object to the learner as tactile feedback.

That is, the following can be performed by setting the target object as a virtual object to which a tactile effect is given (a tactile feedback can be given to the user).
The instructor and the learner can handle the same virtual object.
The instructor and the learner can handle the same virtual object at the same time.
The learner can perform voluntary practice many times in the same state.
If the instruction contents of the instructor are converted into data, it is possible to acquire skills for many people at a time.

The present disclosure can solve the following problems in a case where a target object is a virtual object. The first problem is that it is difficult for the instructor and the learner who are different persons to share tactile feedback to the fingers, which is important for skill acquisition. Even if the target object is the same virtual object, if the instructor who touches the virtual object and the learner are different persons and the way of touching the virtual object is different, the tactile feedback felt by the instructor and the learner is different. Therefore, it is difficult for the instructor and the learner to share tactile feedback to the fingers, which is important for skill acquisition.

The second problem is that the effect of skill acquisition is weakened when the learner repeats voluntary practice using the same virtual object. In the case of a learner, how to touch the virtual object may be different each time. Since the way of touching is different, if the content of the tactile feedback is different every time, the effect of skill acquisition is weakened.

The third problem is that inexperienced learners may not be able to feel a slight change in shape due to the instructor's touch on the virtual object. If a slight shape change of the virtual object is not recognized, skill acquisition may not proceed.

The fourth problem is that when the learner manually deforms the virtual object, it is not clear whether the learner has applied the same force as the instructor. The fifth problem is that it is difficult to continue the state of the same way of touching even when the instructor and the learner can touch the same virtual object in the same way.

In order to solve these problems, an information processing apparatus according to the present disclosure quantitatively indexes a difference in how to touch (a contact state) the virtual object between the instructor and the learner, and notifies the difference in the contact state by a method that allows the instructor and the learner to easily recognize the difference on the basis of the acquired index. Specifically, the information processing apparatus can notify the learner of auxiliary information for assisting the learner to come in contact with the virtual object in the same manner as the instructor. Examples of the notification method of the auxiliary information include visual display, notification by voice, notification by tactile sense, and the like.

Furthermore, the information processing apparatus notifies a slight shape change of the virtual object by a method that is easy for the instructor and the learner to recognize on the basis of the information on the shape change of the virtual object. Examples of the shape change information notifying method for notifying the change in the shape of the virtual object include visual display, notification by voice, notification by tactile sense, and the like.

The information processing apparatus according to the present disclosure can give similar tactile feedback to each user who comes in contact with the same virtual object by substantially matching contact states with the virtual object between a plurality of users (for example, an instructor and a learner) or between the same user in the past and the present. Furthermore, even in a case where the shape of the virtual object has changed, the learner can share the tactile feedback by adjusting the contact state with respect to the virtual object to the contact state of the other party (the instructor or the past self) on the basis of the notification of the shape change of the virtual object from the information processing apparatus.

### First Embodiment

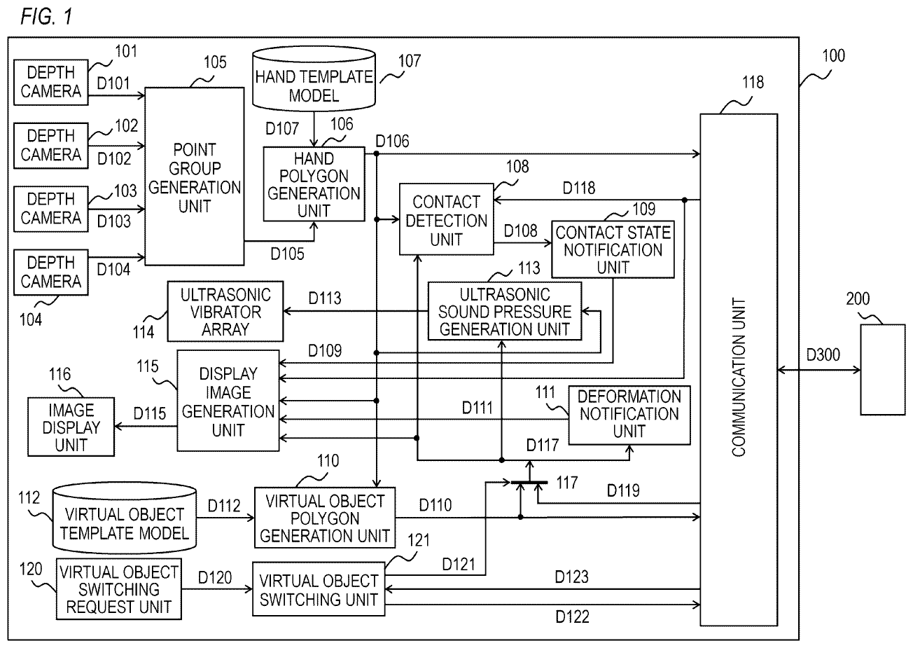

FIG. 1 is a diagram illustrating a configuration of an information processing apparatus 100 according to a first embodiment. The first embodiment illustrates an example in which an instructor and a learner hand down and acquire ceramics, which is a traditional skill in which tactile sense with fingers is important, by touching a common virtual object using respective information processing apparatuses in different spaces.

The information processing apparatus 100 is an apparatus used by the user. An information processing apparatus 200 is an apparatus used by the other party who handles the same virtual object. Since the configuration of the information processing apparatus 200 is the same as the configuration of the information processing apparatus 100, the description thereof will be omitted. The user of the information processing apparatus 100 can reproduce the contact state of the other party with respect to the virtual object while confirming his/her hand, the other party's hand, and the virtual object displayed on the display unit of the information processing apparatus 100. In the following description, a user who uses the information processing apparatus 100 is a learner, and a user who uses the information processing apparatus 200 is an instructor. In the following description, the operation of the information processing apparatus 200 can be described by appropriately replacing the information processing apparatus 100 with the information processing apparatus 200, replacing the learner with the instructor, and replacing the instructor with the learner.

The information processing apparatus 100 acquires an index indicating a difference between the contact state of the learner with respect to the virtual object and the contact state of the instructor with respect to the virtual object detected in a space different from the space of the learner. The information processing apparatus 100 generates, on the basis of the acquired index, auxiliary information for the learner who is in contact with the virtual object to come in contact with the virtual object in a contact state similar to that of the instructor.

The information processing apparatus 100 includes depth cameras 101 to 104, a point group generation unit 105, a hand polygon generation unit 106, a hand template model 107, a contact detection unit 108, a contact state notification unit 109, a virtual object polygon generation unit 110, and a deformation notification unit 111. Furthermore, the information processing apparatus 100 includes a virtual object template model 112, an ultrasonic sound pressure generation unit 113, an ultrasonic vibrator array 114, a display image generation unit 115, an image display unit 116, a selector 117, and a communication unit 118.

The depth cameras 101 to 104 capture images of the hand of the learner (the instructor in the information processing apparatus 200), and output the depth camera outputs D101 to D104 to the point group generation unit 105. The point group generation unit 105 generates the point group data D105 of the hand of the learner from the depth camera outputs D101 to D104.

The hand polygon generation unit 106 dynamically generates hand polygon data (polygon mesh model data) D106 of the learner on the basis of the hand template model data D107 and the point group data D105 stored in advance in the hand template model 107. The hand polygon generation unit 106 dynamically generates hand polygon data by the method disclosed in “Tactile rendering to the finger surface by aerial ultrasonic control”. The generated hand polygon data D106 of the learner is transmitted to the contact detection unit 108, the virtual object polygon generation unit 110, the ultrasonic sound pressure generation unit 113, the display image generation unit 115, and the communication unit 118.

The virtual object polygon generation unit 110 generates the virtual object polygon data D110 from the virtual object template model data D112 stored in advance in the virtual object template model 112. The virtual object polygon generation unit 110 can generate the virtual object polygon data D110 by performing deformation processing on the virtual object template model data D112 on the basis of the positional relationship with the hand polygon data D106 of the learner.

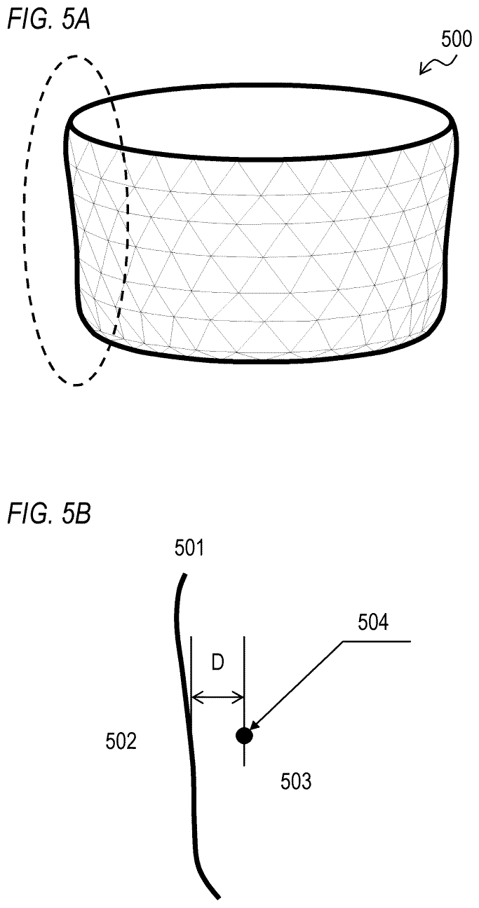

For example, in a case where the virtual object is a vessel produced by ceramics, the virtual object polygon generation unit 110 can model a process of finishing the vessel while the learner manually deforms the virtual object representing clay molded into the shape of the vessel. A method for generating the virtual object polygon data D110 will be described later with reference to FIGS. 5A and 5B. The virtual object polygon data D110 is transmitted to the selector 117 of the virtual object polygon mesh model and the communication unit 118.

The selector 117 switches the virtual object polygon mesh model based on a virtual object select signal D121 output from a virtual object switching unit 121.

A virtual object switching request unit 120 of the information processing apparatus 100 receives a switching request on whether to use the virtual object polygon data D110 or the virtual object polygon data D119 on the instructor side acquired from the information processing apparatus 200 from the learner. The virtual object switching request unit 120 of the information processing apparatus 200 receives, from the instructor, a switching request as to whether to use the virtual object polygon data D110 or the virtual object polygon data D119 on the learner side acquired from the information processing apparatus 100.

The timing at which the instructor or the learner requests to switch the virtual object polygon mesh model includes, for example, the following four timings.
(1) Timing when the instructor tries to present an example to the learner.
(2) Timing when the instructor tries to know the situation of the learner.
(3) Timing when the learner tries to confirm the example of the instructor.
(4) Timing when the learner indicates his/her situation to the instructor.

The virtual object switching request unit 120 of the information processing apparatus 100 transmits the virtual object switching request signal D120 to the virtual object switching unit 121 when receiving a request for switching the virtual object polygon mesh model from the learner. The virtual object switching unit 121 outputs the virtual object select signal D121 generated on the basis of the virtual object switching request signal D120 to the selector 117. The virtual object switching unit 121 transmits the virtual object switching notification signal D122 indicating the content of the request for switching the virtual object polygon mesh model received from the learner to the information processing apparatus 200 via the communication unit 118. The virtual object switching notification signal D122 is a signal for notifying the information processing apparatus 200 on the instructor side of the virtual object switching request signal D120 generated by the request of the learner.

On the other hand, when the virtual object switching request unit 120 of the information processing apparatus 200 receives a request for switching the virtual object polygon mesh model from the instructor, the virtual object switching unit 121 of the information processing apparatus 100 receives the virtual object switching notification signal D123 from the information processing apparatus 200. The virtual object switching notification signal D123 is a signal for notifying the information processing apparatus 100 on the learner side of the virtual object switching request signal D120 generated by the information processing apparatus 200 according to the request of the instructor.

The virtual object switching unit 121 generates the virtual object select signal D121 at the timings (1) to (4) using the virtual object switching request signal D120 or the virtual object switching notification signal D123 received from the other party side.

At the timings (1) and (3), the selector 117 of the information processing apparatus 100 selects the virtual object polygon data D119 on the other party side, and the selector 117 of the information processing apparatus 200 selects the virtual object polygon data D110 on the own side. At the timings (2) and (4), the selector 117 of the information processing apparatus 100 selects the virtual object polygon data D1110 on the own side, and the selector 117 of the information processing apparatus 200 selects the virtual object polygon data D119 on the other party side.

The virtual object polygon data D117 selected by the selector 117 is the virtual object polygon data designated by the instructor or the learner, and the instructor and the learner can share the same virtual object. The virtual object polygon data D117 selected by the selector 117 is transmitted to the contact detection unit 108, the ultrasonic sound pressure generation unit 113, and the deformation notification unit 111.

The contact detection unit 108 generates a contact state detection result D108 by using the hand polygon data D106 of the learner (own side), the virtual object polygon data D117 selected by the selector 117, and the hand polygon data D118 of the instructor (other party side). The contact detection unit 108 transmits the generated contact state detection result D108 to the contact state notification unit 109.

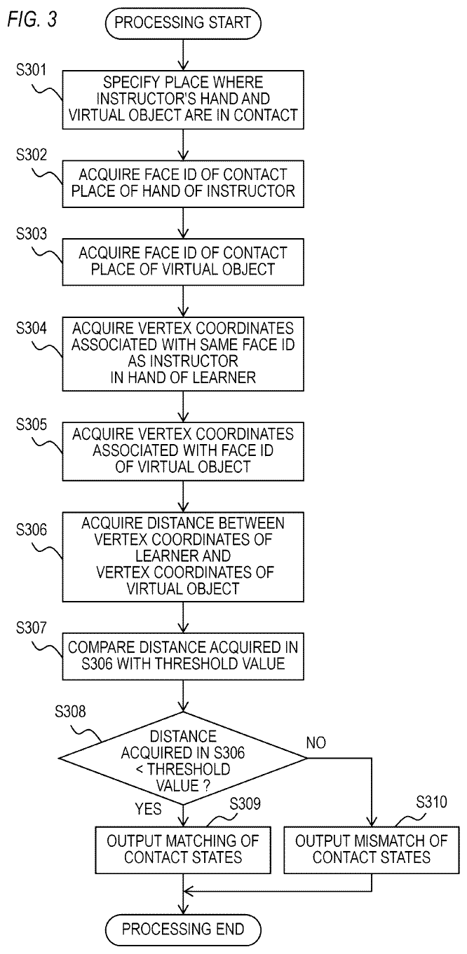

The contact detection unit 108 detects a place such as a hand that comes into contact with a specific place of the virtual object. In addition, the contact detection unit 108 determines whether the place in contact with the specific place of the virtual object is substantially the same between the learner and the instructor. That is, the contact detection unit 108 determines whether or not the contact state of the learner with respect to the virtual object is the same as the contact state of the instructor with respect to the virtual object. Details of the processing of the contact detection unit 108 will be described later with reference to the flowchart of FIG. 3.

The deformation notification unit 111 detects a change in the virtual object polygon data D117 selected by the selector 117 and generates the deformation notification data D111 (shape change information) of the virtual object. The deformation notification data D111 is used to notify the change in the shape of the virtual object when the shape of the virtual object changes according to the contact state of the learner. The deformation notification unit 111 transmits the generated deformation notification data D111 to the display image generation unit 115. The contact state notification unit 109 generates the contact state detection result notification data D109 on the basis of the contact state detection result D108 and transmits the contact state detection result notification data D109 to the display image generation unit 115.

The display image generation unit 115 generates an image of the virtual object based on the virtual object polygon data D117, an image of the hand based on the hand polygon data D106 of the learner, and an image of the hand based on the hand polygon data D118 of the instructor. Since the image based on the polygon data can be generated using a known computer graphics technology, detailed description thereof is omitted.

On the basis of the contact state detection result notification data D109, the display image generation unit 115 generates first notification image data for notifying the contact state between the instructor and the virtual object and the contact state between the learner and the virtual object. In addition, the display image generation unit 115 generates second notification image data for notifying deformation of the virtual object on the basis of the deformation notification data D111.

The display image generation unit 115 transmits the display image data D115 to the image display unit 116. The display image data D115 includes the image of the virtual object, the image of the hand of the learner, the image of the hand of the instructor, the first notification image data, and the second notification image data. The image display unit 116 may be, for example, a head mounted display or a stereoscopic display device. In the following description, the image display unit 116 is a stereoscopic display device.

The ultrasonic sound pressure generation unit 113 calculates a contact portion between the hand of the learner and the virtual object on the basis of the hand polygon data D106 of the learner and the virtual object polygon data D117 selected by the selector 117. The ultrasonic sound pressure generation unit 113 generates the ultrasonic sound pressure control data D113 in which the amplitude and the phase of the ultrasonic wave emitted by the ultrasonic vibrator array 114 are adjusted such that a predetermined sound pressure is generated at the contact portion between the hand of the learner and the virtual object. The ultrasonic sound pressure generation unit 113 transmits the generated ultrasonic sound pressure control data D113 to the ultrasonic vibrator array 114.

The ultrasonic vibrator array 114 irradiates a position to which a tactile sense is given with an ultrasonic wave on the basis of the ultrasonic sound pressure control data D113. By extending a hand to the vicinity of the ultrasonic vibrator array 114 of the information processing apparatus 100, the learner can feel the feel of the virtual object as a tactile sense. In this manner, the tactile effect felt by the learner can be generated by the ultrasonic sound pressure. The generation of the ultrasonic sound pressure control data D113 can be realized using the technology disclosed in “Tactile rendering to the finger surface by aerial ultrasonic control”.

The communication unit 118 of the information processing apparatus 100 transmits and receives the communication data D300 to and from the information processing apparatus 200. The communication unit 118 transmits, for example, the hand polygon data D106 of the learner, the virtual object polygon data D110 on the learner side, and the virtual object switching notification signal D122 transmitted from the learner side to the instructor side to the information processing apparatus 200.

On the other hand, the communication unit 118 of the information processing apparatus 200 transmits the hand polygon data D106 of the instructor, the virtual object polygon data D110 on the instructor side, and the virtual object switching notification signal D122 transmitted from the instructor side to the learner side to the information processing apparatus 100. The communication unit 118 of the information processing apparatus 100 receives the data transmitted by the information processing apparatus 200 as the hand polygon data D118 of the instructor, the virtual object polygon data D119 on the instructor side, and the virtual object switching notification signal D123 from the instructor side to the learner side.

The information processing apparatus 100 and the information processing apparatus 200 can display a hand on the own side, a hand on the other party side, a virtual object on the own side, or a virtual object on the other party side on the image display unit 116 by using the mutually transmitted and received data.

Note that a method of providing tactile feedback from the virtual object is not limited to a method of tactile feedback to the bare hand by ultrasonic sound pressure. It is sufficient that the instructor or the learner can recognize the contact place between the hand and the virtual object, and the method of giving the tactile feedback may be a method of wearing the tactile feedback device on the hand in the form of a so-called haptics glove.

### Detection of Contact State

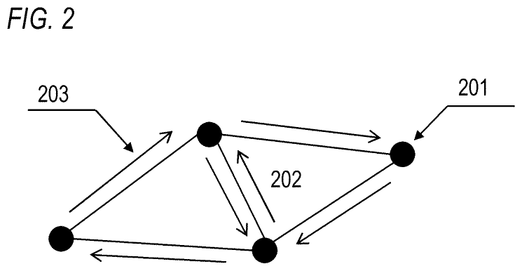

With reference to FIGS. 2, 3, and 4A to 4C, a method in which the contact detection unit 108 detects the contact state between the hand and the virtual object and determines whether or not the contact state of the learner with respect to the virtual object is substantially the same as the contact state of the instructor with respect to the virtual object will be described. The contact detection unit 108 is only required to determine whether or not the place of the hand of the learner who is in contact with the specific place of the virtual object is substantially the same as the place of the hand of the instructor who is in contact with the specific place of the virtual object.

FIG. 2 is a diagram for explaining a polygon mesh model. FIG. 2 illustrates a portion of a triangular polygon mesh model. The triangular polygon mesh model is represented by vertexes 201, faces 202, and half-edges 203. The vertex 201 is represented by three-dimensional coordinate information (x, y, z), and indicates position information of the polygon. The face 202 is represented by Index information of a face associated with the vertex 201. The half edge 203 is represented by Index information having a clockwise or counterclockwise attribute. Two (In and Out) half edges 203 are associated with one vertex.

By using the face 202 and the half edge 203, specific places of the hands of the instructor and the learner, for example, the fingertip of the index finger, the vicinity of the first joint, the vicinity of the base of the middle finger, or the like can be represented by Index. By using the vertex 201 associated with the face 202 and the half edge 203, the three-dimensional coordinates of the specific places of the hands of the instructor and the learner can be quantified. Similarly, the three-dimensional coordinates of a particular place of the virtual object that the instructor or learner intends to touch can be quantified.

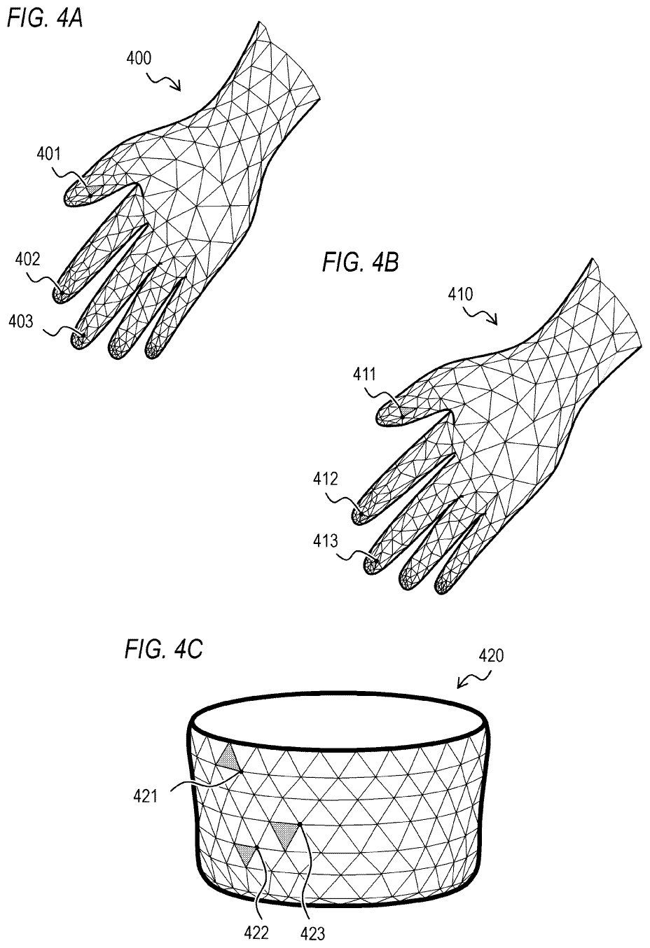

FIG. 3 is a flowchart illustrating contact state detection processing. FIG. 4A is an example of a hand polygon mesh model of an instructor. FIG. 4B is an example of a hand polygon mesh model of a learner. FIG. 4C is an example of a virtual object polygon mesh model. FIGS. 4A to 4C illustrate examples of faces and vertexes specified in the contact state detection processing of FIG. 3.

The hand polygon mesh model 400 of the instructor corresponds to the hand polygon data D118 of the instructor received from the information processing apparatus 200. The hand polygon mesh model 410 of the learner corresponds to the hand polygon data D106 generated by the hand polygon generation unit 106. The virtual object polygon mesh model 420 corresponds to the virtual object polygon data D117 selected by the selector 117.

The hand polygon mesh model 400 of the instructor and the hand polygon mesh model 410 of the learner are generated using a template model common to the instructor and the learner in the hand template model 107. The hand of the instructor and the hand of the learner can be represented by the polygon mesh model having the same number of vertexes by using the common template model even if the shapes are different depending on individual differences. The dynamic fitting processing of the polygon mesh model can be realized by the technology disclosed in “Tactile rendering to the finger surface by aerial ultrasonic control”.

The contact state detection processing illustrated in FIG. 3 will be described. The processing in steps S301 to S303 in FIG. 3 is processing of detecting the contact state of the instructor with the virtual object. The processing of detecting the contact state includes specifying a contact place with which the user contacts the virtual object, and acquiring coordinates of a vertex associated with the (face) of the contact place of the user and coordinates of a vertex associated with the (face) of the contact place of the virtual object.

In step S301, the contact detection unit 108 specifies a place where the instructor's hand and the virtual object are in contact. The contact detection unit 108 specifies a contact place on the hand polygon mesh model 400 of the instructor (hand polygon data D118 of the instructor) and on the virtual object polygon mesh model 420. The specification of the contact place in step S301 can be realized by the technology disclosed in “Tactile rendering to the finger surface by aerial ultrasonic control”.

In step S302, the contact detection unit 108 acquires Index (hereinafter, described as a face ID) of a face of a contact place on the hand polygon mesh of the instructor acquired in step S301. In the example of FIG. 4A, the contact detection unit 108 acquires a first vertex 401, a second vertex 402, and a third vertex 403 corresponding to the contact place, and the face IDs of the faces associated with the respective vertexes.

In step S303, the contact detection unit 108 acquires the face ID of the contact place (contact face) on the virtual object polygon mesh acquired in step S301. In the example of FIG. 4C, the contact detection unit 108 acquires the face IDs of the faces associated with each of vertexes of a seventh vertex 421, an eighth vertex 422, and a ninth vertex 423 corresponding to the contact place. By the processing of steps S301 to S303, information on the contact state of the instructor with the virtual object is acquired.

In step S304, the contact detection unit 108 acquires coordinates of a vertex associated with a face on the hand polygon mesh model 410 of the learner (hand polygon data D106 of the learner) having the same face ID as the face associated with the first vertex 401 acquired in step S302. In the example of FIG. 4B, the contact detection unit 108 acquires vertex coordinates of a fourth vertex 411. Similarly, the contact detection unit 108 acquires vertex coordinates of a fifth vertex 412 and a sixth vertex 413.

In step S305, the contact detection unit 108 acquires the vertex coordinates of each of a seventh vertex 421, an eighth vertex 422, and a ninth vertex 423 associated with the face ID of the contact place (contact face) on the virtual object polygon mesh model 420 acquired in step S303.

In step S306, the contact detection unit 108 acquires the distance between the vertex coordinates of the fourth vertex 411 and the seventh vertex 421, the distance between the vertex coordinates of the fifth vertex 412 and the eighth vertex 422, and the distance between the vertex coordinates of the sixth vertex 413 and the ninth vertex 423. Equation 1 is an example of a calculation formula of the distance between the vertex coordinates. When the distance between the fourth vertex 411 and the seventh vertex 421 is calculated, X1, Y1, and Z1 in Equation 1 are vertex coordinates of the fourth vertex 411, and X2, Y2, and Z2 are vertex coordinates of the seventh vertex 421. Equation 1 exemplifies an equation for calculating the Euclidean distance Du between the fourth vertex 411 and the seventh vertex 421.

$$\begin{matrix}[ Math . 1 ] & \\ {D}_{u} = {\{ {( {X}_{1} - {X}_{2} )}^{2} + {( {Y}_{1} - {Y}_{2} )}^{2} + {( {Z}_{1} - {Z}_{2} )}^{2} \}}^{\frac{1}{2}} & ( Equation 1 )\end{matrix}$$

By the processing from steps S301 to S306, the contact detection unit 108 acquires the Euclidean distance between the position on the virtual object in contact with the instructor and the position on the hand of the learner corresponding to the position where the hand of the instructor is in contact with the virtual object. The position on the virtual object corresponds to the first position indicated by the coordinates (X2, Y2, Z2) in Equation 1. The position on the hand of the learner corresponding to the position where the hand of the instructor is in contact with the virtual object corresponds to the second position indicated by the coordinates (X1, Y1, Z1) in Equation 1. The Euclidean distance Du is an example of an index indicating a difference between the contact state of the hand of the learner with respect to the virtual object and the contact state of the hand of the instructor with respect to the virtual object detected in a space different from the space of the learner.

In step S307, the contact detection unit 108 compares the distance between the vertex coordinates acquired in step S306 with a threshold value. In step S308, the contact detection unit 108 determines whether or not the distance acquired in step S306 is shorter than the threshold value. In a case where the distance acquired in step S306 is shorter than the threshold value, the processing proceeds to step S309. In a case where the distance acquired in step S306 is equal to or more than the threshold value, the processing proceeds to step S310.

In step S309, since the place of the hand of the instructor who comes in contact with the specific place of the virtual object can be regarded as substantially the same as the place of the hand of the learner who comes in contact with the specific place of the virtual object, the contact detection unit 108 outputs a result that the contact states coincide with each other. In a case where the place of the hand of the instructor who comes into contact with the specific place of the virtual object is the same as the place of the hand of the learner who comes into contact with the specific place of the virtual object, the faces having the same face ID in the respective hand polygon mesh models are in contact with the specific place.

In step S310, the contact detection unit 108 outputs a result that the contact states do not match between the instructor and the learner. When a determination result as to whether the contact states match or do not match is output in steps S309 and S310, the processing illustrated in FIG. 3 ends.

The index indicating the difference between the contact state of the hand of the learner with respect to the virtual object and the contact state of the hand of the instructor with respect to the virtual object detected in the space different from the space of the learner is not limited to the Euclidean distance between the vertexes expressed by Equation 1. The index indicating the difference between the contact state of the hand of the learner with respect to the virtual object and the contact state of the hand of the instructor with respect to the virtual object only needs to be able to define the distance between the first position and the second position, and may be an index for multivariate analysis such as the Mahalanobis distance. In addition, the index indicating the difference between the contact state of the hand of the learner with respect to the virtual object and the contact state of the hand of the instructor with respect to the virtual object may be a result determined using the deep learning network.

### Polygon Data Generation of Virtual Object

With reference to FIGS. 5A and 5B, a method in which the virtual object polygon generation unit 110 generates the virtual object polygon data D110 will be described. FIG. 5A illustrates a virtual object template model 500. FIG. 5B is a diagram for describing a surface boundary 501 of a portion surrounded by a broken line in the virtual object template model 500 of FIG. 5A.

FIG. 5B illustrates positions of the surface boundary 501, an outer region 502 of the surface boundary 501, an inner region 503 of the surface boundary 501, and the vertex 504 of the hand polygon mesh of the virtual object template model 500.

For skill acquisition in which a tactile sense with fingers is important, a virtual object is an object having elastoplasticity that is easy to process and deform with fingers. FIG. 5B illustrates a state in which the instructor or learner has moved the hand so that the vertexes 504 of the hand polygon mesh enter the inner region 503 across the surface boundary 501 of the virtual object template model 500.

When the vertex 504 of the hand polygon mesh enters the inner region 503 across the surface boundary 501 of the virtual object template model 500 by the distance D, the virtual object polygon generation unit 110 performs the deformation processing on the virtual object template model 500. The virtual object polygon generation unit 110 performs the deformation processing on the virtual object template model 500 so that the surface boundary 501 gradually moves to the vertex 504 of the hand polygon mesh. The deformation processing on the virtual object template model 500 can be realized by the technology disclosed in “Tactile rendering to the finger surface by aerial ultrasonic control”. The virtual object polygon generation unit 110 performs deformation processing on the virtual object template model data D112 on the basis of the distance D, and generates the virtual object polygon data D110.

### Notification of Auxiliary Information and Shape Change Information

The display image data D115, the contact state detection result notification data D109, and the deformation notification data D111 illustrated in FIG. 1 will be described. The display image data D115 is generated by the display image generation unit 115. The contact state detection result notification data D109 is generated by the contact state notification unit 109 and used to display the auxiliary information. The contact state detection result notification data D109 is superimposed on the display image data D115 and displayed on the image display unit 116. The contact state detection result notification data D109 is data for notifying the user (instructor, learner, etc.) of the contact state with respect to the virtual object. The contact state detection result notification data D109 is not limited to the case of being displayed on the image display unit 116, and may be used to notify the contact state with the virtual object by voice or tactile sense. The deformation notification data D111 is generated by the deformation notification unit 111 and used to display shape change information.

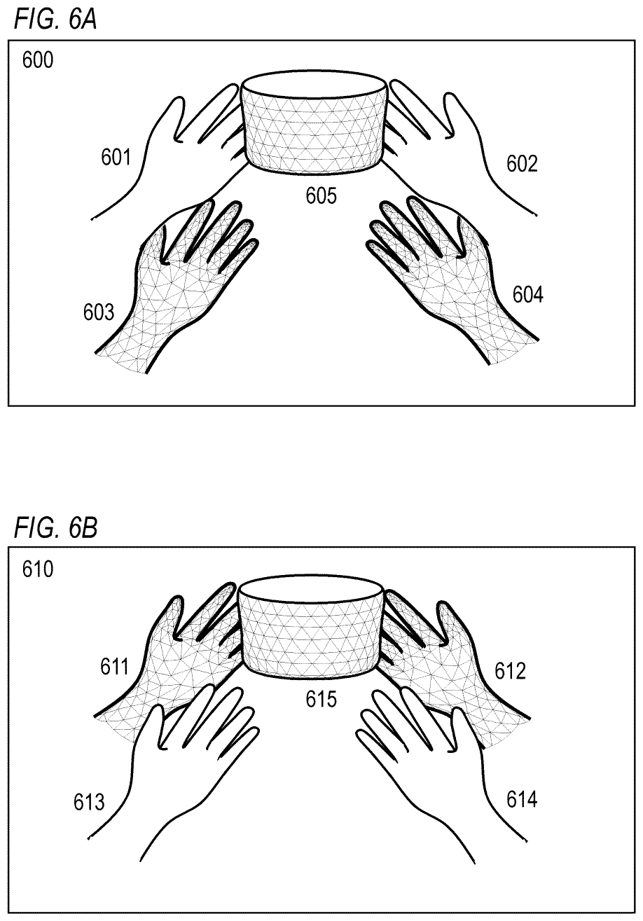

FIGS. 6A and 6B illustrate examples of display images displayed on the image display unit 116 in a situation where the instructor is touching the virtual object, and the learner is about to touch the virtual object in accordance with the hand of the instructor. The image display unit 116 displays a display image based on the display image data D115 generated by the display image generation unit 115. The image display unit 116 is, for example, a stereoscopic display device, and the user's own hand of the information processing apparatus 100 is viewed with the user's own naked eye in front of the stereoscopic display device.

FIG. 6A illustrates a display screen (display content) 600 of the image display unit 116 of the information processing apparatus 200. FIG. 6B illustrates a display screen (display content) 610 of the image display unit 116 of the information processing apparatus 100.

The display screen 600 of the information processing apparatus 200 displays a virtual object 605 which is a CG image, and a left hand 601 and a right hand 602 of an instructor who touches the virtual object 605 and intends to perform processing. In addition, the display screen 600 displays a left hand 603 and a right hand 604 of the learner, which are CG images generated on the basis of the polygon data D118 received from the information processing apparatus 100.

Similarly, the display screen 610 of the information processing apparatus 100 displays a virtual object 615 that is a CG image, and a left hand 611 of the CG image and a right hand 612 of the CG image of the instructor who touches the virtual object 615 and intends to perform processing. In addition, the display screen 610 displays a left hand 613 and a right hand 614 of the learner who intends to touch the virtual object 615 in accordance with the left hand 611 and the right hand 612 of the instructor.

In FIGS. 6A and 6B, the hand of the learner is not in a state of touching the virtual object in accordance with the hand of the instructor. For this reason, the notification about the contact state of the hand of the instructor and the hand of the learner with respect to the virtual object is not displayed.

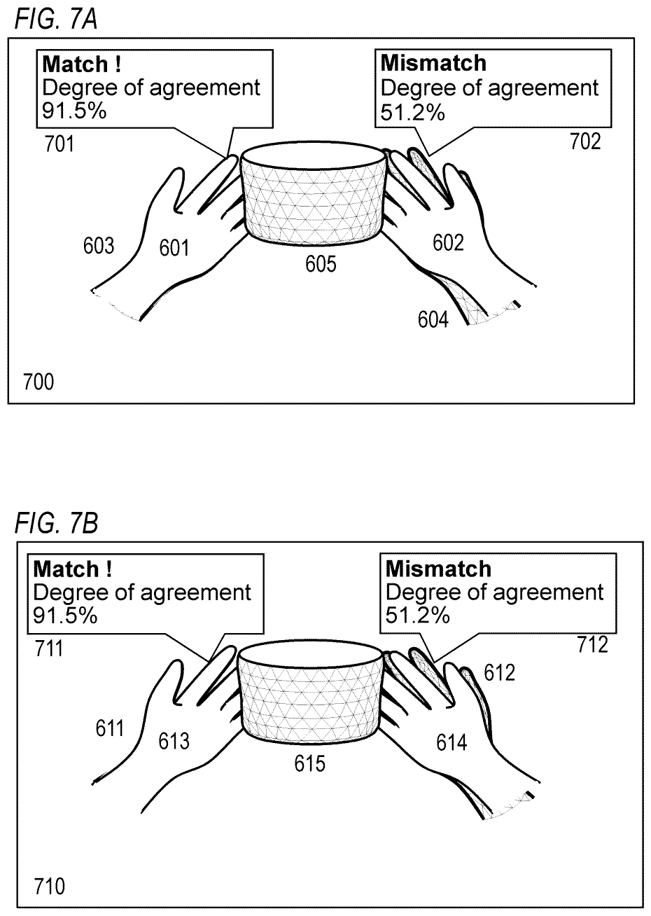

FIGS. 7A and 7B illustrate examples of display images displayed on the image display unit 116 in a situation where the instructor is touching the virtual object and the learner is touching the virtual object in accordance with the hand of the instructor. FIG. 7A illustrates a display screen (display content) 700 of the image display unit 116 of the information processing apparatus 200. FIG. 7B illustrates a display screen (display content) 710 of the image display unit 116 of the information processing apparatus 100.

In addition to the display content of FIG. 6A, the display screen 700 of the information processing apparatus 200 superimposes and displays notifications 701 and 702 regarding the contact state between the hands of the instructor and the learner and the virtual object. Furthermore, the display screen 710 of the information processing apparatus 100 superimposes and displays notifications 711 and 712 regarding the contact state between the hands of the instructor and the learner and the virtual object, in addition to the display content of FIG. 6B.

In FIGS. 7A and 7B, the hand of the learner is in a state of touching the virtual object in accordance with the hand of the instructor. The contact detection unit 108 determines that the contact state of the left hand of the learner is substantially the same as the contact state of the left hand of the instructor, but the contact state of the right hand of the learner is different from the contact state of the right hand of the instructor.

The notification 701 in FIG. 7A notifies that the contact state of the left hand 601 of the instructor with respect to the virtual object 605 substantially matches (Match) the contact state of the left hand 603 of the learner with respect to the virtual object 605. The notification 702 notifies that the contact state of the right hand 602 of the instructor with respect to the virtual object 605 does not match (Mismatch) the contact state of the right hand 604 of the learner with respect to the virtual object 605. The notifications 701 and 702 may display the degree of agreement of the contact states as a percentage.

The notification 711 in FIG. 7B notifies that the contact state of the left hand 613 of the learner with respect to the virtual object 615 substantially matches (Match) the contact state of the left hand 611 of the instructor with respect to the virtual object 615. The notification 712 notifies that the contact state of the right hand 614 of the learner with respect to the virtual object 615 does not match (Mismatch) the contact state of the right hand 612 of the instructor with respect to the virtual object 615. The notifications 711 and 712 may display the degree of agreement of the contact states as a percentage.

The contact detection unit 108 compares the distance between the vertexes of the virtual object polygon mesh model 420 and the hand polygon mesh model 410 of the learner with the threshold value at three points where the hand polygon mesh model 400 of the instructor comes into contact with the virtual object polygon mesh model 420. The contact detection unit 108 can determine whether the contact states match or do not match at each of the three points. The contact detection unit 108 may determine the degree of agreement of the contact state between the hand and the virtual object displayed in the notifications 701, 702, 711, and 712 on the basis of the matching degree and the mismatch degree at each of the three vertexes. For example, in a case where it is determined that all of the contact states coincide with each other at the three vertexes (distance between vertexes<threshold value), the contact detection unit 108 can set the degree of agreement between the contact states to 100%.

As the contact portion between the hand and the virtual object becomes wider, the number of places where the distance between the vertexes is compared with the threshold value increases, so that the accuracy of the percentage indicating the degree of agreement of the contact states is improved. For example, the contact detection unit 108 may determine matching (Match) when the percentage is 90% or more, and may determine mismatching (Mismatch) when the percentage is less than 90%. The threshold value for determining whether to match or mismatch is not limited to 90%, and may be set in advance according to the type of the virtual object or the skill, or may be set by the user.

The contents of the notifications 701, 702, 711, and 712 are generated by the display image generation unit 115 on the basis of the contact state detection result notification data D109 generated by the contact state notification unit 109. The display of the notifications 701, 702, 711, and 712 allows the instructor and the learner to easily recognize whether or not the way of touching the virtual object is common to each other. In a case where the contact state with the virtual object is substantially the same, the tactile feedback generated by the ultrasonic sound pressure generation unit 113 can be regarded as being substantially the same between the instructor and the learner.

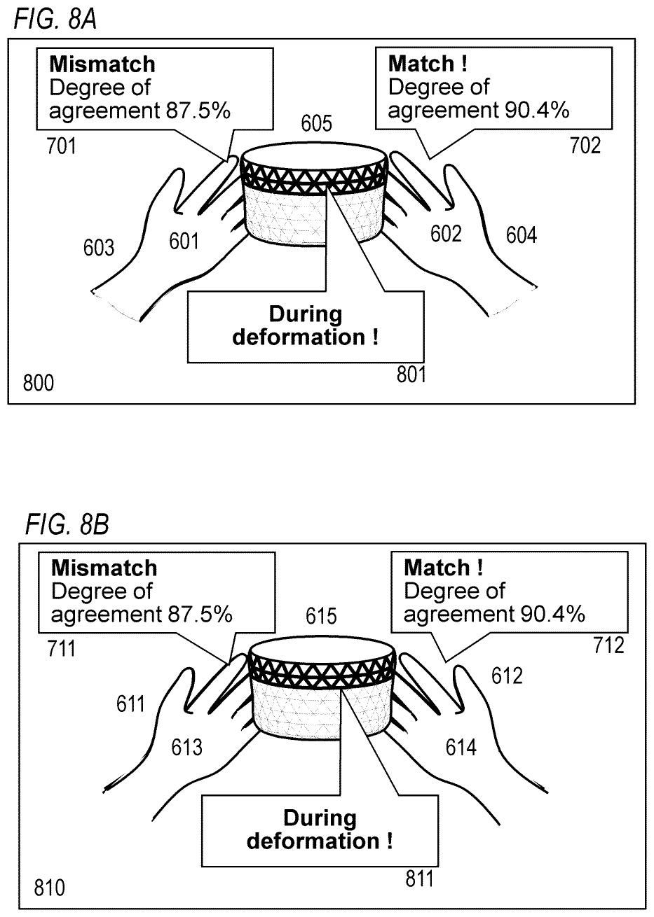

FIGS. 8A and 8B illustrate examples of display images displayed on the image display unit 116 in a case where the virtual object polygon generation unit 110 performs the deformation processing on the virtual object template model data D112 according to the movement of the hand of the instructor or the learner. FIG. 8A illustrates a display screen (display content) 800 of the image display unit 116 of the information processing apparatus 200. FIG. 8B illustrates a display screen (display content) 810 of the image display unit 116 of the information processing apparatus 100.

In addition to the display content of FIG. 7A, the display screen 800 of the information processing apparatus 200 superimposes and displays a notification 801 notifying that the shape of the virtual object 605 has changed due to the deformation processing being performed on the virtual object 605. Furthermore, in addition to the display content of FIG. 7B, the display screen 810 of the information processing apparatus 100 superimposes and displays a notification 811 notifying that the shape of the virtual object 615 has changed due to the deformation processing being performed on the virtual object 615.

When the deformation processing is performed on the virtual object template model data D112, information on the deformation processing is transmitted to the deformation notification unit 111 together with the virtual object polygon data D117 selected by the selector 117. The deformation notification unit 111 generates the deformation notification data D111 on the basis of the virtual object polygon data D117 and the information on the deformation processing.

The notifications 801 and 811 in FIGS. 8A and 8B are display examples of notification based on the deformation notification data D111. The display image generation unit 115 can specify a place where deformation has occurred on the virtual object polygon data D117 on the basis of the deformation notification data D111. Therefore, the display image generation unit 115 can display the fact that the shape of the virtual object has changed as character information, and can change the display so that the user can easily recognize the place where the shape has changed in the virtual object of the CG image. In the virtual objects 605 and 615 of FIGS. 8A and 8B, the place where the shape has changed is drawn with a darker line than the place where the shape has not changed.

In a case where the shapes of the virtual objects 605 and 615 change, the contact states between the hands of the instructor and the learner and the virtual objects change. Therefore, in FIGS. 8A and 8B, the display contents (Match/Mismatch indication, percentage indication) of 701, 702, 711, and 712 are updated.

The display, such as notifications 801 and 811, allows the instructor and the learner to confirm the deformation of the virtual object with information other than tactile feedback. Therefore, the instructor and the learner can more correctly recognize and understand the slight degree of deformation.

In the first embodiment described above, the information processing apparatus 100 quantitatively indexes the difference in the contact state between the instructor and the learner with respect to the virtual object, and generates the auxiliary information for the learner to contact the virtual object in the same contact state as the instructor on the basis of the acquired index. The auxiliary information is visually displayed in the first embodiment. The learner can easily reproduce the contact state of the instructor with the virtual object by confirming the auxiliary information.

### Second Embodiment

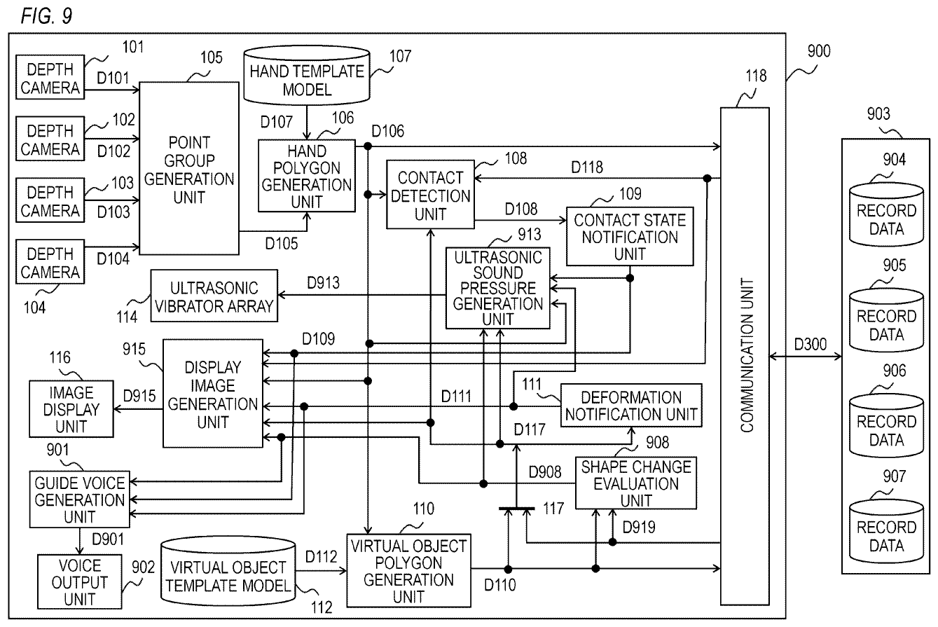

FIG. 9 is a diagram illustrating a configuration of an information processing apparatus 900 according to the second embodiment. The second embodiment illustrates an example in which the learner performs acquisition by voluntary practice of ceramics, which is a traditional skill in which a tactile sense with fingers is important, by touching a common virtual object using the information processing apparatus 900 at different times.

The information processing apparatus 900 acquires an index indicating a difference between the past contact state with respect to the virtual object and the current contact state of the learner with respect to the virtual object detected at a time different from the past contact state. The information processing apparatus 900 generates auxiliary information for the learner who is in contact with the virtual object to come in contact with the virtual object in a contact state similar to the past contact state on the basis of the acquired index.

In FIG. 9, the same components, data, and signals as those of the information processing apparatus 100 according to the first embodiment illustrated in FIG. 1 are denoted by the same reference numerals as those in FIG. 1, and description thereof is omitted.

The information processing apparatus 900 according to the second embodiment includes a guide voice generation unit 901, a voice output unit 902, and a shape change evaluation unit 908 as components different from those of the information processing apparatus 100 according to the first embodiment. An ultrasonic sound pressure generation unit 913 and a display image generation unit 915 of the information processing apparatus 900 are different in processing from the ultrasonic sound pressure generation unit 113 and the display image generation unit 115 of the information processing apparatus 100. The information processing apparatus 900 is connected to an external storage device 903. The external storage device 903 includes record data 904 to 907. Hereinafter, for the second embodiment, differences from the first embodiment will be described.

The connection destination of the information processing apparatus 900 is not the information processing apparatus 200 but the external storage device 903. The information processing apparatus 900 transmits and receives communication data D300 similar to that of the first embodiment to and from the external storage device 903.

The record data 904 of the external storage device 903 records the hand polygon data D106 of the past learner. The record data 905 records the past virtual object polygon data D110. The record data 904 and the record data 905 record the movement of the hand of the learner performed in the past and the deformation information of the virtual object, and are referred to for the learner to perform voluntary practice.

The record data 906 records the hand polygon data of the instructor recorded in the same format as the record data 904 that is the hand polygon data D106 of the learner. The record data 907 records the polygon data of the virtual object handled by the instructor recorded in the same format as the record data 905 which is the polygon data D110 of the virtual object handled by the learner. The record data 906 and the record data 907 are referred to for the learner to perform voluntary practice using the movement of the hand of the instructor and the deformation information of the virtual object as examples.

The record data 906 which is the hand polygon data of the instructor and the record data 907 which is the polygon data of the virtual object handled by the instructor are obtained through, for example, a communication network or a medium such as a memory card.

The learner can select whether to use the record data 904 and the record data 905 or to use the record data 906 and the record data 907 by using the user interface included in the information processing apparatus 900.

The virtual object polygon data of either the record data 905 or the record data 907 is selected and input to the shape change evaluation unit 908 as the reproduced polygon data D919 of the virtual object. The shape change evaluation unit 908 compares the current virtual object polygon data D1110 of the learner with the reproduced polygon data D919 of the virtual object to evaluate the change in shape.

The shape change evaluation unit 908 calculates the distance between the vertex coordinates associated with the faces having the same index, for example, by calculation similar to Equation 1. The smaller the distance between the vertex coordinates associated with the faces having the same index, the higher the degree of agreement between the current virtual object polygon data D110 and the reproduced polygon data D919 of the virtual object. That is, the degree of agreement in shape between the current virtual object and the past virtual object or the virtual object that is an example of the instructor becomes high.

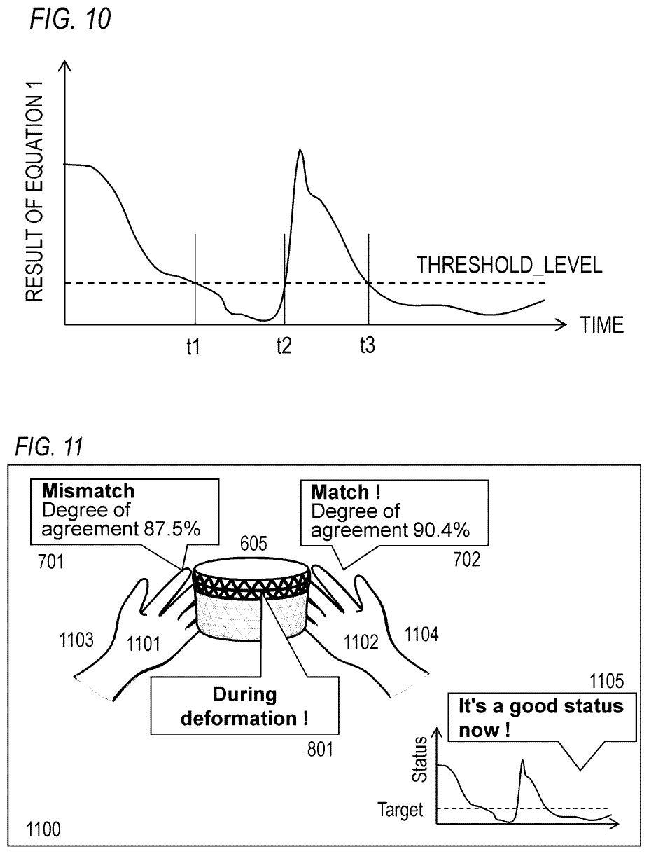

FIG. 10 is a graph exemplifying an evaluation result by the shape change evaluation unit 908. The graph of FIG. 10 is a graph illustrating a change in the distance between the vertexes of the current virtual object polygon data D110 and the reproduced polygon data D919 of the virtual object. The horizontal axis represents time. The vertical axis represents the calculation result of the distance between the vertexes by Equation 1. When comparing a plurality of vertexes, the vertical axis can be a calculation result obtained by integrating distances between the plurality of vertexes.

The calculation result of Equation 1 is compared with the threshold value THRESHOLD_LEVEL illustrated in FIG. 10. The graph of FIG. 10 indicates that the degree of agreement in shapes of the virtual objects is high from time t1 to t2 and after time t3 when the calculation result of Equation 1 is equal to or less than the threshold value THRESHOLD_LEVEL. The evaluation result by the shape change evaluation unit 908 is transmitted to the guide voice generation unit 901, the ultrasonic sound pressure generation unit 913, and the display image generation unit 915 as a shape change evaluation signal D908.

FIG. 11 illustrates an example of a display image displayed on the image display unit 116 on the basis of the display image data D915 generated by the display image generation unit 915. FIG. 11 illustrates a display screen (display content) 1100 of the image display unit 116 of the information processing apparatus 900. In FIG. 11, the same elements as those in FIG. 8A are denoted by the same reference numerals, and description thereof is omitted.

In FIG. 11, the left hand 1101 of the learner and the right hand 1102 of the learner substantially overlap the left hand 1103 of the past learner which is the CG image and the right hand 1104 of the past learner which is the CG image, respectively. The left hand 1101 of the learner and the right hand 1102 of the learner are in a state of touching the virtual object 605 which is the CG image.

The notification 701 indicating the degree of agreement of the left hand, the notification 702 indicating the degree of agreement of the right hand, and the notification 801 regarding the shape change of the virtual object are similar to those in FIG. 6A. The display screen 1100 of the information processing apparatus 900 displays the evaluation result 1105 by the shape change evaluation unit 908 in addition to the notifications 701, 702, and 801. The information of the evaluation result 1105 is included in the display image data D915 generated by the display image generation unit 915 on the basis of the shape change evaluation signal D908.

By referring to the evaluation result 1105 of the shape change of the virtual object, the learner can confirm that processing different from processing performed on the virtual object by the learner himself/herself in the past has been performed and that the shape of the virtual object after processing is different from the shape of the virtual object after processing in the past. The learner can efficiently acquire the technique of processing the virtual object into substantially the same shape as the past by repeatedly performing practice while confirming the difference in the contact state using the past own data.

In addition, in a case where the record data 906 of the hand polygon data of the instructor and the record data 907 of the polygon data of the virtual object handled by the instructor are selected as the reproduced polygon data D919 of the virtual object, the learner can compare the own processing result with the processing result of the instructor. By comparing the processing result with the processing result of the instructor, the learner can more clearly consciously practice the method of processing the virtual object including the method of applying force to the virtual object by the instructor.

The guide voice generation unit 901 receives the shape change evaluation signal D908, the contact state detection result notification data D109, and the deformation notification data D111 as inputs, generates a guide voice signal D901, and transmits the guide voice signal to the voice output unit 902. The voice output unit 902 is a speaker, a headphone, or the like.

The guide voice signal D901 is data in which the display content described as the visual information in FIGS. 7A, 7B, 8A, 8B, and 11 is set as voice information. By notifying the information displayed as the visual information by voice from the voice output unit 902, the learner can also confirm the information regarding the contact state by the voice information.

The ultrasonic sound pressure generation unit 913 generates ultrasonic sound pressure control data D913 that provides a tactile sense of the virtual object on the basis of the hand polygon data D106 of the learner and the virtual object polygon data D117 selected by the selector 117. The ultrasonic sound pressure generation unit 913 may further generate ultrasonic sound pressure control data D913 of the following three patterns as auxiliary tactile information.

The ultrasonic sound pressure control data D913 of the first pattern generates the ultrasonic sound pressure for notifying the contents of the notifications 701, 702, 711, and 712 described with reference to FIGS. 7A and 7B on the basis of the contact state detection result notification data D109. For example, the ultrasonic sound pressure generation unit 913 generates the ultrasonic sound pressure control data D913 so as to give different tactile sense in a case where the contact states match with each other and in a case where the contact states do not match with each other.

The ultrasonic sound pressure control data D913 of the second pattern generates the ultrasonic sound pressure for notifying the contents of the notifications 801 and 811 described with reference to FIGS. 8A and 8B on the basis of the deformation notification data D111. For example, the ultrasonic sound pressure generation unit 913 generates the ultrasonic sound pressure control data D913 so as to give different tactile senses to the position of the hand touching the deformed portion of the virtual object and the position of the hand touching the non-deformed portion of the virtual object.

The ultrasonic sound pressure control data D913 of the third pattern generates the ultrasonic sound pressure notifying the contents of the evaluation result 1105 by the shape change evaluation unit 908 described with reference to FIG. 11 based on the shape change evaluation signal D908. For example, the ultrasonic sound pressure generation unit 913 generates the ultrasonic sound pressure control data D913 so as to give a different tactile sense according to whether or not the calculation result of the distance between the vertexes indicating the shape change of the virtual object (the value on the vertical axis of the graph of FIG. 10) is equal to or less than the threshold value THRESHOLD_LEVEL.

In the second embodiment described above, the information processing apparatus 900 enables the learner to reproduce the processing (processing or the like) for the past virtual object stored in the external storage device 903. The information processing apparatus 900 indexes a difference between the processing of the past learner or the processing of the past instructor and the processing of the current learner, and generates auxiliary information for contacting the virtual object in the same contact state as the contact state in the past processing on the basis of the acquired index. The learner can repeatedly practice the processing on the virtual object by comparing the past own processing or the past instructor processing with the current own processing on the basis of the auxiliary information.

In the second embodiment, the information processing apparatus 900 generates the ultrasonic sound pressure control data D913 for notifying information equivalent to the display image data D915 generated by the display image generation unit 915 as tactile information. The learner can also recognize, as the tactile information, information equivalent to the content displayed as the visual information on the basis of the display image data D915.

### Third Embodiment

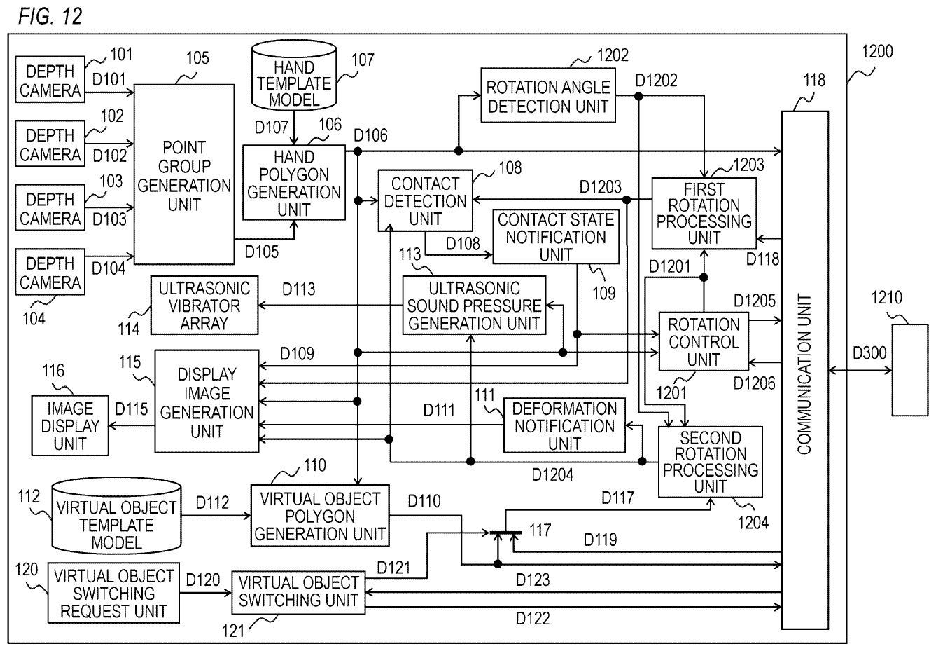

FIG. 12 is a diagram illustrating a configuration of an information processing apparatus 1200 according to a third embodiment. The third embodiment illustrates an example in which an instructor and a learner hand down and acquire ceramics, which is a traditional skill in which a tactile sense with fingers is important, by touching a common virtual object using respective information processing apparatuses in different spaces.

The information processing apparatus 1200 is an apparatus used by the user. An information processing apparatus 1210 is an apparatus used by the other party who handles the same virtual object. Since the configuration of the information processing apparatus 1210 is the same as the configuration of the information processing apparatus 1200, the description thereof will be omitted. In the following description, a user who uses the information processing apparatus 1200 is a learner, and a user who uses the information processing apparatus 1210 is an instructor. In the following description, the operation of the information processing apparatus 1210 can be described by appropriately replacing the information processing apparatus 1200 with the information processing apparatus 1210, replacing the learner with the instructor, and replacing the instructor with the learner. In FIG. 12, the same components, data, and signals as those of the information processing apparatus 100 according to the first embodiment illustrated in FIG. 1 are denoted by the same reference numerals as those in FIG. 1, and description thereof is omitted.

The information processing apparatus 1200 according to the third embodiment includes a rotation control unit 1201, a rotation angle detection unit 1202, a first rotation processing unit 1203, and a second rotation processing unit 1204 as components different from those of the information processing apparatus 100 according to the first embodiment. Hereinafter, for the third embodiment, differences from the first embodiment will be described.

In the third embodiment, it is controlled such that after the contact state of the learner with respect to the virtual object becomes substantially the same as the contact state of the instructor with respect to the virtual object, the contact state with respect to the virtual object substantially the same as the instructor is maintained in accordance with the movement of the part (for example, a hand) of the learner with respect to the virtual object. It may be controlled such that after the contact state of the learner with respect to the virtual object becomes substantially the same as the contact state of the past learner with respect to the virtual object, the contact state with respect to the virtual object substantially the same as the past himself/herself (learner) is maintained in accordance with the movement of the part of the learner in contact with the virtual object.

In addition to the communication in the first embodiment, the communication unit 118 transmits and receives a rotation processing cancellation output signal D1205 and a rotation processing cancellation input signal D1206 to and from the information processing apparatus 1210 as communication data D300.

The rotation processing cancellation output signal D1205 is a signal for notifying the information processing apparatus 1210 that the rotation processing on the virtual object polygon data D117 selected by the selector 117 and the polygon data D118 received from the information processing apparatus 1210 is canceled. The rotation processing cancellation input signal D1206 is a signal that the information processing apparatus 1200 receives the rotation processing cancellation output signal D1205 output by the information processing apparatus 1210.

The rotation processing is processing of rotating the virtual object polygon data D117 and the hand polygon data D118 of the instructor in accordance with the movement of the hand of the learner in a case where the learner rotates the hand in the information processing apparatus 1200, for example. Note that, although the rotation processing will be described below, in a case where the learner moves the hand, the virtual object polygon data D117 and the hand polygon data D118 of the instructor may be moved in accordance with the movement of the hand of the learner.

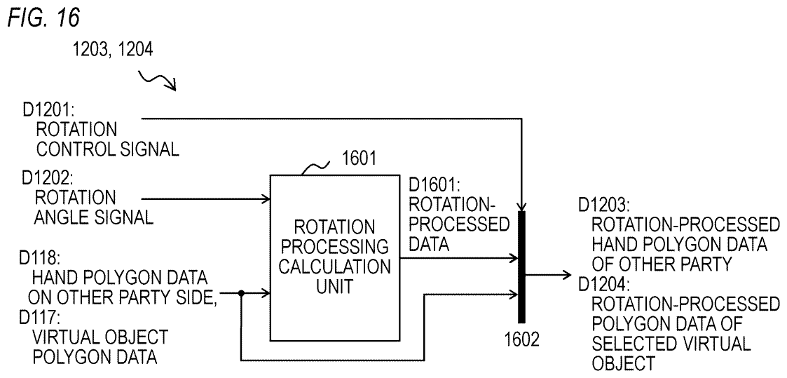

The rotation control unit 1201 generates and outputs a rotation control signal D1201 and the rotation processing cancellation output signal D1205 on the basis of the contact state detection result notification data D109, the hand polygon data D106, and the rotation processing cancellation input signal D1206. An operation example of the rotation control unit 1201 will be described later with reference to the timing chart of FIG. 16.

The rotation processing of polygon data will be described. The first rotation processing unit 1203 performs predetermined rotation processing on the hand polygon data D118 of the instructor received from the information processing apparatus 1210. The second rotation processing unit 1204 performs predetermined rotation processing on the virtual object polygon data D117 selected by the selector 117.

The first rotation processing unit 1203 and the second rotation processing unit 1204 perform rotation processing on the polygon data by existing computer graphics technology on the basis of the input rotation angle signal D1202. The first rotation processing unit 1203 generates hand polygon data D1203 of the instructor subjected to the rotation processing. The second rotation processing unit 1204 generates polygon data D1204 of the virtual object subjected to the rotation processing. The hand polygon data D1203 of the instructor subjected to the rotation processing and the polygon data D1204 of the virtual object subjected to the rotation processing are used instead of the hand polygon data D118 and the virtual object polygon data D117 described in the first embodiment. Details of the first rotation processing unit 1203 and the second rotation processing unit 1204 will be described later with reference to FIG. 16.

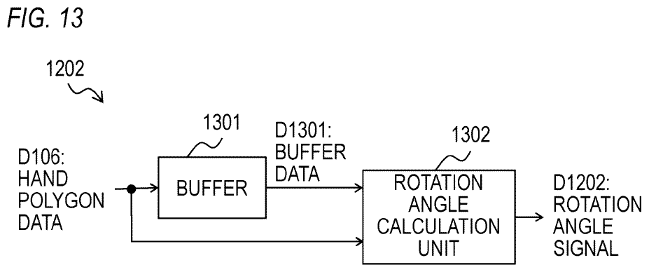

FIG. 13 is a diagram illustrating a configuration of the rotation angle detection unit 1202. The rotation angle detection unit 1202 generates a rotation angle signal D1202 for notifying the first rotation processing unit 1203 and the second rotation processing unit 1204 of the rotation angle when the hand of the instructor and the virtual object are rotated.

The rotation angle detection unit 1202 includes a buffer 1301 and a rotation angle calculation unit 1302. The buffer 1301 temporarily stores the hand polygon data (polygon mesh model data) D106 of the learner, and generates the buffer data D1301 of the hand polygon data D106.

The rotation angle calculation unit 1302 calculates a rotation angle of the hand polygon data D106 of the learner based on the buffer data D1301 and vertex coordinates of the hand polygon data D106 of the learner, and generates the rotation angle signal D1202 indicating how the hand of the learner has rotated. The rotation angle can be calculated using existing computer graphics technology.

The first rotation processing unit 1203 rotates the hand of the instructor and the second rotation processing unit 1204 rotates the virtual object on the basis of the rotation angle of the hand of the learner detected by the rotation angle detection unit 1202. The learner can view the CG image of the hand of the instructor and the CG image of the virtual object in a rotated state following the change in the rotation angle of the own hand in the information processing apparatus 1200.

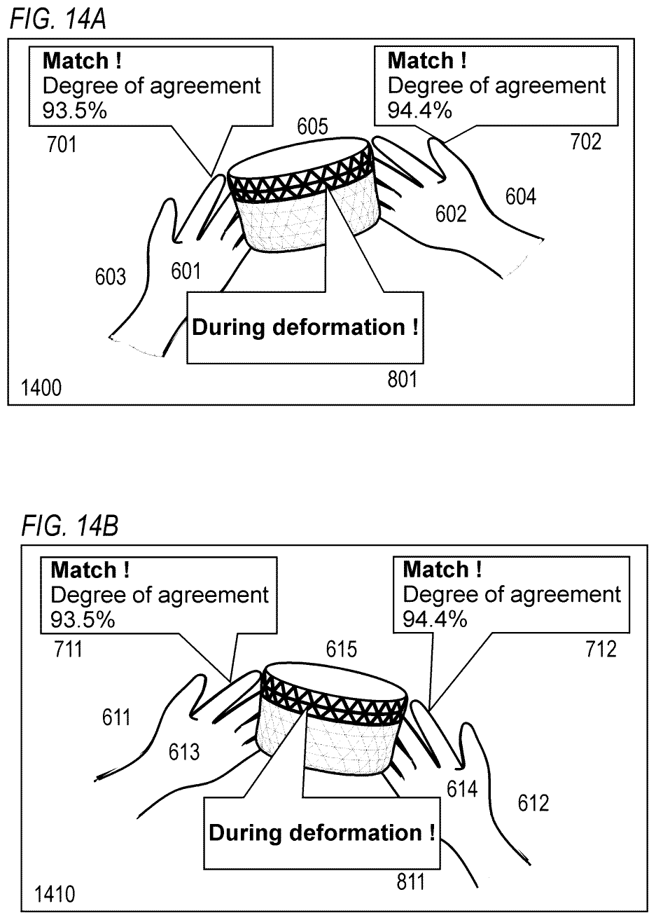

FIG. 14A illustrates a display screen 1400 of the third embodiment corresponding to the display screen 800 of the first embodiment described in FIG. 8A. FIG. 14B illustrates a display screen 1410 of the third embodiment corresponding to the display screen 810 of the first embodiment described in FIG. 8B.

On the display screen 1400, the virtual object 605 rotates in accordance with the instructor's hands 601 and 602 touching the virtual object 605, so that the instructor's hands 601 and 602 appear to be adsorbed to the virtual object 605. In addition, since the learner's hands 603 and 604 of the CG image rotate similarly to the virtual object 605, the hands rotate in a state of being overlapped with the instructor's hands 601 and 602.

On the display screen 1410, since the virtual object 615 rotates in accordance with the learner's hands 613 and 614 touching the virtual object 615, the learner's hands 613 and 614 appear to be attracted to the virtual object 615. Furthermore, since the instructor's hands 611 and 612 of the CG image rotate similarly to the virtual object 615, the hands rotate in a state of being overlapped with the learner's hands 613 and 614.

The display screen 1400 displays the notifications 701, 702, and 801 similarly to the display screen 800. The display screen 1410 displays the notifications 711, 712, and 811 similarly to the display screen 810.

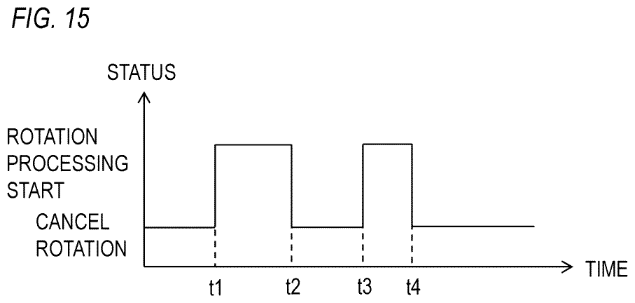

The operation of the rotation control unit 1201 (control unit) will be described with reference to FIG. 15. FIG. 15 is a diagram illustrating a timing chart of the rotation control signal D1201. In a case where it can be determined by the contact state detection result notification data D109 that the learner and the instructor are touching the same portion of the virtual object at substantially the same place of the hand, the rotation control unit 1201 sets the rotation control signal D1201 to the rotation processing start state (Time t1, t3).

In a case where it is detected from the coordinate information of the hand polygon data D106 of the instructor that the hand of the learner has moved out of the range of the ultrasonic sound pressure irradiation of the ultrasonic vibrator array 114, the rotation control unit 1201 sets the rotation control signal D1201 to the rotation processing cancellation state (time t2). That is, in a case where the hand of the learner has moved out of the range in which the tactile effect on the virtual object can be imparted, the rotation control unit 1201 stops the control to maintain the contact state with the virtual object in accordance with the movement of the hand of the learner. When bringing the rotation control signal D1201 into the rotation processing cancellation state, the rotation control unit 1201 outputs a rotation processing cancellation output signal D1205.

In a case where the rotation processing cancellation input signal D1206 is input, the rotation control unit 1201 determines that the hand of the instructor has moved out of the range of the ultrasonic sound pressure irradiation of the ultrasonic vibrator array 114 of the information processing apparatus 200, and sets the rotation control signal D1201 to the rotation processing cancellation state (time t4). That is, in a case where the hand of the instructor on the other party side moves out of the range where the tactile effect on the virtual object can be imparted, the rotation control unit 1201 stops the control to maintain the contact state with the virtual object in accordance with the movement of the hand of the learner. When bringing the rotation control signal D1201 into the rotation processing cancellation state, the rotation control unit 1201 outputs a rotation processing cancellation output signal D1205.

Note that the rotation control unit 1201 may bring the rotation control signal D1201 into the rotation processing cancellation state in accordance with an instruction from the instructor or the learner. For example, the instructor or the learner may be able to cancel the rotation processing by voice.

FIG. 16 is a diagram illustrating a configuration of the first rotation processing unit 1203 and the second rotation processing unit 1204. The first rotation processing unit 1203 and the second rotation processing unit 1204 include a rotation processing calculation unit 1601 and a selector 1602.

On the basis of the rotation angle signal D1202, the rotation processing calculation unit 1601 of the first rotation processing unit 1203 performs rotation processing on the hand polygon data D118 of the instructor (the other party side) using a known computer graphics technology. The rotation processing calculation unit 1601 generates the rotation-processed data D1601 of the hand polygon data D118 of the instructor.

On the basis of the rotation angle signal D1202, the rotation processing calculation unit 1601 of the second rotation processing unit 1204 performs rotation processing on the virtual object polygon data D117 using a known computer graphics technology. The rotation processing calculation unit 1601 generates the rotation-processed data D1601 of the virtual object polygon data D117.

When the rotation control signal D1201 is in the rotation processing start state, the selector 1602 of the first rotation processing unit 1203 selects the rotation-processed data D1601 of the hand polygon data D118 of the instructor. When the rotation control signal D1201 is in the rotation processing cancellation state, the selector 1602 selects the hand polygon data D118 of the instructor.

When the rotation control signal D1201 is in the rotation processing start state, the selector 1602 of the second rotation processing unit 1204 selects the rotation-processed data D1601 of the virtual object polygon data D117. When the rotation control signal D1201 is in the rotation processing cancellation state, the selector 1602 selects the virtual object polygon data D117.

In the information processing apparatus 1200, after it is determined that the instructor and the learner are touching the virtual object in the same state, the learner can touch the virtual object without continuing to hold the virtual object at the position of the same hand. Similarly, in the information processing apparatus 1210, after it is determined that the instructor and the learner are touching the virtual object in the same state, the instructor can touch the virtual object without continuing to hold the virtual object at the position of the same hand. Since the instructor and the learner can freely confirm the virtual object, the burden of instruction and learning is reduced.

In addition, in a case where the hand of the instructor or the learner moves out of the range of the ultrasonic sound pressure irradiation of the ultrasonic vibrator array 114, the rotation processing is canceled. In addition, the rotation processing may be canceled by an instruction of the instructor or the learner. Therefore, the instructor or the learner can easily cancel the rotation processing in which the virtual object and the hand of the other party rotate in accordance with the movement of the own hand. When the rotation processing is canceled, the information processing apparatuses 1200 and 1210 are returned to the original use state, and can notify the instructor and the learner of the contact state with the virtual object.

According to the third embodiment described above, the information processing apparatus 1200 can rotate the virtual object and the hand of the instructor in accordance with the movement of the hand of the learner. Therefore, the learner can easily confirm the state of the virtual object and the hand of the instructor, and efficiently acquire skills from the instructor. Similarly, the information processing apparatus 1210 can rotate the virtual object and the hand of the learner in accordance with the movement of the hand of the instructor. Therefore, the instructor can easily confirm the state of the virtual object and the hand of the learner, and can efficiently instruct the learner.

Note that each of the above embodiments has been described as an example in which a virtual object is clay molded into a shape of a vessel and skills in ceramics are taught or learned, but the virtual object and the skills are not limited thereto. The virtual object only needs to have moderate elastoplasticity, and may be, for example, food such as bread dough, pie dough, and dough of noodles, food such as hand-shaped sushi and cake, or a living body such as a human body and an animal body. Skills corresponding to these virtual objects may be skills such as making bread, making pies, making noodles and buckwheat noodles, and medical skills performed with bare hands such as massage.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to support a contact state with a virtual object so that the contact state can be reproduced at different times or in different spaces.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016786, filed Feb. 4, 2025, which is hereby incorporated by reference herein in its entirety.

What is claimed is:

1. An information processing apparatus comprising:
a processor; and
a memory storing a program which, when executed by the processor, causes the information processing apparatus to:
execute detection processing of detecting a contact state with respect to a virtual object to which a tactile effect is imparted;
execute acquisition processing of acquiring an index indicating a difference between a first contact state with respect to the virtual object and a second contact state with respect to the virtual object, the second contact state being detected in a time different from the first contact state or in a space different from the first contact state; and
execute generation processing of generating, based on the index, auxiliary information for a user contacting the virtual object in the second contact state to contact the virtual object in the first contact state.

2. The information processing apparatus according to claim 1, wherein the program, when executed by the processor, further causes the information processing apparatus to execute notification processing of notifying the auxiliary information by at least one of the methods of visual display, notification by voice, and notification by tactile sense.

3. The information processing apparatus according to claim 1, wherein the tactile effect is generated by ultrasonic sound pressure.

4. The information processing apparatus according to claim 1, wherein in the generation processing, in a case where the shape of the virtual object has changed in accordance with the first contact state, shape change information for notifying a change in the shape of the virtual object is further generated.

5. The information processing apparatus according to claim 4, wherein the program, when executed by the processor, further causes the information processing apparatus to execute second notification processing of notifying the shape change information by at least any method of visual display, notification by voice, and notification by tactile sense.

6. The information processing apparatus according to claim 1, wherein the program, when executed by the processor, further causes the information processing apparatus to execute control processing of controlling to maintain the first contact state with respect to the virtual object in accordance with movement of a part of the user in contact with the virtual object after a contact state of the user with respect to the virtual object changes from the second contact state to the first contact state.

7. The information processing apparatus according to claim 6, wherein in the control processing, when the part of the user in contact with the virtual object moves out of a range where the tactile effect on the virtual object is impartible, control for maintaining the first contact state with respect to the virtual object in accordance with movement of the part is stopped.

8. The information processing apparatus according to claim 1, wherein the index is a Euclidean distance or a Mahalanobis distance between a first position on the virtual object that is in contact with a first user in the first contact state and a second position that is a position in the first user or a second user in the second contact state corresponding to a position in the first user that is in contact with the first position.

9. An information processing method comprising:
detecting a contact state with respect to a virtual object to which a tactile effect is imparted;
acquiring an index indicating a difference between a first contact state with respect to the virtual object and a second contact state with respect to the virtual object, the second contact state being detected in a time different from the first contact state or in a space different from the first contact state; and
generating, based on the index, auxiliary information for a user contacting the virtual object in the second contact state to contact the virtual object in the first contact state.

10. A non-transitory computer-readable medium that stores a program, wherein the program causes a computer to execute an information processing method comprising:
detecting a contact state with respect to a virtual object to which a tactile effect is imparted;
acquiring an index indicating a difference between a first contact state with respect to the virtual object and a second contact state with respect to the virtual object, the second contact state being detected in a time different from the first contact state or in a space different from the first contact state; and
generating, based on the index, auxiliary information for a user contacting the virtual object in the second contact state to contact the virtual object in the first contact state.
